(19) United States
(12) Patent Application Publication
(10) Pub. No.: US 2015/0134554 A1
(43) Pub. Date: May 14, 2015

(54) NETWORK VISUALIZATION FOR EMPLOYMENT PROFILING

(71) Applicant: Work 4 Labs, Inc., San Francisco, CA (US)

(72) Inventors: Paul CLAIS, Courbevoie (FR); Guillaume LESEUR, Nogent Sur Marne (FR); Ouadia LASFAR, Choisy le Roi (FR)

(21) Appl. No.: 14/527,548

(22) Filed: Oct. 29, 2014

Related U.S. Application Data
(60) Provisional application No. 61/902,688, filed on Nov. 11, 2013.

(51) Int. Cl. G06Q 10/10; G06F 17/30; G06Q 50/00

(52) U.S. Cl. CPC G06Q 10/1053; G06Q 50/01; G06F 17/30867
USPC 705/321

(57) ABSTRACT

Various of the disclosed embodiments present systems and methods for visualizing social network information to identify correlations between employees and their peers. In some embodiments, the system may receive a list of candidates for the position and a list of employees well-suited to their existing positions. The system may then consider social network information to identify relations between the employees and the candidates as relates to the various job positions. The relations may be identified by applying various functions of differing granularity. Once the relations are identified, the system may present the relations in an edge-node depiction to a recruiter. The recruiter may then use the visualization to inform the next step in their decision process (e.g., identify an employee to recommend candidate peers, identify candidates for interviews, etc.).

### CROSS REFERENCE TO RELATED APPLICATIONS

This application claims the priority and benefit of U.S. Provisional Patent Application No. 61/902,688, entitled “VISUALIZATION OF NETWORKS OF JOBS TO PROFILE MATCHES” (Attorney Docket 110555-8006.US00), filed Nov. 11, 2013 the contents of which are incorporated by reference herein in their entirety for all purposes.

### BACKGROUND

Identifying optimal pairings between job candidates and job openings is a challenging task. Presenting candidates with unsuitable openings may cause them to lose interest in the network and to forsake the job search completely. If a candidate should accept a suboptimal pairing, they may feel unfulfilled and perform beneath expectations. Similarly, the organization may resent the opportunity cost in hiring a suboptimal employee and prefer that another candidate had filled the role instead. Accordingly, it is desirable to identify pairings which are both desired by the applicant as well as aligned with the interests of the requesting organization.

While the Internet has increased access both to job openings and to candidates, job posting and candidate information is rarely presented in a consolidated form. Social networks (e.g., Facebook®, LinkedIn®) may indirectly reflect useful information regarding potential applicants to various positions, but the data is generally not managed in a form suitable for a recruiter to analyze. Attempts by machine learning systems to recognizes patterns and correlations in the disparate data have been generally unsatisfactory. Computers are often poor substitutes for past, real-world recruiting experience and fail to account for various real-world contextual factors (e.g., automated methods may identify keywords in a social network profile, but may not infer that the candidate has divergent interests from those required in the position). Accordingly, there exists a need for automated methods to consolidate posting information to facilitate subsequent candidate-posting matching and review.

### BRIEF DESCRIPTION OF THE DRAWINGS

The techniques introduced here may be better understood by referring to the following Detailed Description in conjunction with the accompanying drawings, in which like reference numerals indicate identical or functionally similar elements:

FIG. 1 is a block diagram of a topology for a social network visualization system as may be implemented in some embodiments;

FIG. 2 is a block diagram illustrating components in a scoring portion of a social network visualization system as may be created in some embodiments;

FIG. 3 is a flow diagram illustrating a process for generating a network visualization as may be applied in some embodiments;

FIG. 4 is an example Graphical User Interface (GUI) presenting a network visualization as may be implemented in some embodiments; and

FIG. 5 is a block diagram of a computer system as may be used to implement features of some of the embodiments.

While the flow and sequence diagrams presented herein show an organization designed to make them more comprehensible by a human reader, those skilled in the art will appreciate that actual data structures used to store this information may differ from what is shown, in that they, for example, may be organized in a different manner; may contain more or less information than shown; may be compressed and/or encrypted; etc.

The headings provided herein are for convenience only and do not necessarily affect the scope or meaning of the embodiments. Further, the drawings have not necessarily been drawn to scale. For example, the dimensions of some of the elements in the figures may be expanded or reduced to help improve the understanding of the embodiments. Similarly, some components and/or operations may be separated into different blocks or combined into a single block for the purposes of discussion of some of the embodiments. Moreover, while the various embodiments are amenable to various modifications and alternative forms, specific embodiments have been shown by way of example in the drawings and are described in detail below. The intention, however, is not to limit the particular embodiments described. On the contrary, the embodiments are intended to cover all modifications, equivalents, and alternatives falling within the scope of the disclosed embodiments.

### DETAILED DESCRIPTION

Various of the disclosed embodiments present systems and methods for visualizing social network information to identify correlations between employees, their peers, and/or various job positions. In some embodiments, the system may receive a list of candidates for the position and a list of employees well-suited to their existing positions. The system may then consider social network information to identify relations between the employees and the candidates as relates to the various job positions. The relations may be identified by applying various functions of differing granularity. Once the relations are identified, the system may present the relations in, e.g., an edge-node depiction to a recruiter. The recruiter may then use the visualization to inform the next step in their decision process (e.g., identify an employee to recommend candidate peers, identify candidates for interviews, etc.).

Various examples of the disclosed techniques will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the techniques can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this section.

Overview—Example System Topology

Various of the disclosed embodiments provide visualizations to assist recruiters when comparing a set of candidates with a set of company employees and/or job descriptions to identify, e.g., the best potentially fitting candidates. The visualizations may allow the recruiter to explore the company employees' social network to actively identify good potential candidates as well as those employees best positioned to provide referrals. In this manner, the recruiter can leverage their past experience and contextual understanding of the position's requirements, while accessing the relevant data in a more efficient manner.

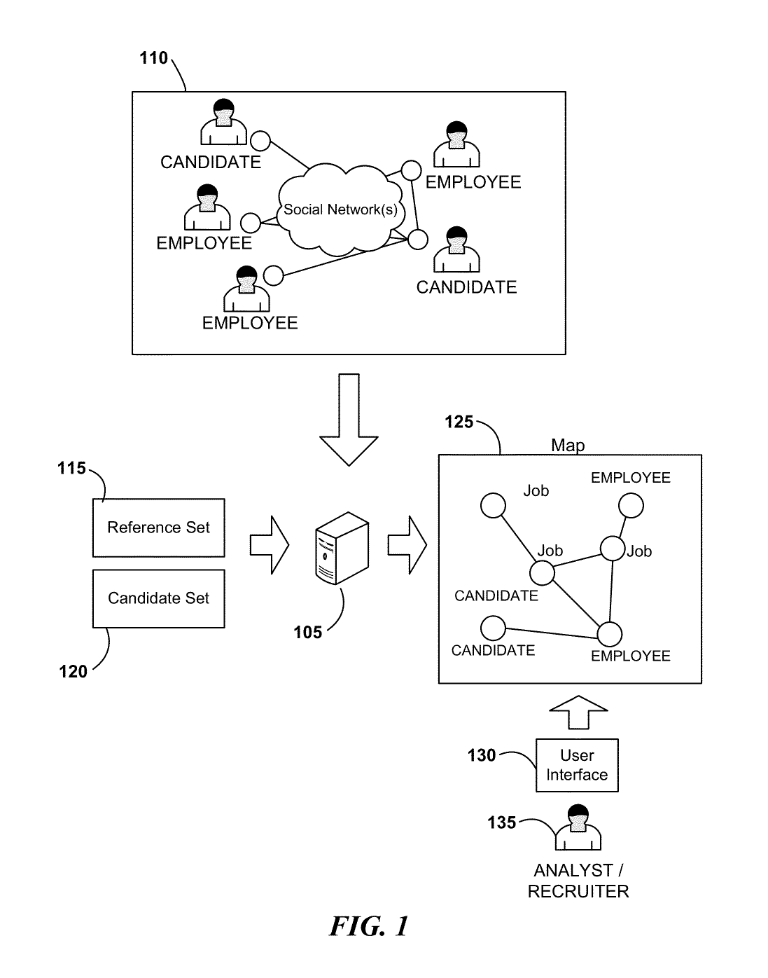

FIG. 1 is a block diagram of a topology for a social network visualization system as may be implemented in some embodiments. A social network 110 may include users, some of whom are current or past employees of an organization and some of whom are being considered for various job positions. Though depicted here as a single social network, the social network 110 may include both personal (e.g., Facebook®) and professional (e.g., LinkedIn®) social network information. Similarly, in some embodiments a candidate may also be an employee (e.g. where the recruiter seeks to identify applicants within an organization as well as outside the organization).

A visualization system 105 may be used by a recruiter to visualize correspondences between the candidates, employees, and possibly one or more job positions. The system 105 may receive a reference set 115 from a recruiter upon which to base the assessment. The reference set 115 may indicate the existing or past employees and/or desired job positions to be considered when assessing the candidates. The employees may reflect “known matches” for the job positions, e.g., in that they have a desired attributes and are able to successfully fulfill the requirements of a similar or same job description. For example, a recruiter seeking a Python programmer may include a job description for the position in the reference set 115 as well as a list of employees known within the organization as being excellent Python programmers.

The recruiter may also provide the visualization system 105 with a candidate set 120. The candidate set 120 may indicate the individuals that are being considered for a given job position. Candidates can be applicants, referrals, or any social network user profile which can be accessed. The visualization system 105 may refer to the social network 110 to acquire attributes for and to infer relations between the employees and the candidates. The visualization system 105 may apply scoring functions between entities in the network and the job positions to identify candidates who possess desired qualities. These scoring functions may compare the social attributes retrieved from the network with one another and/or with job posting information to assess the relatedness of the attributes.

The visualization system 105 may then generate a visualization 125 which may be viewed and possibly manipulated by a user. For example, the recruiter 135 may be able to dynamically modify the edge-node representation in the visualization 125 via user interface 130 to better observe candidate-employee and candidate-job posting relations. Nodes may be moved around, parameters dictating their connections and distances adjusted, etc.

Though the reference set 115 and candidate set 120 may be a list of candidates, in some embodiments, the system 105 may simply receive a parameter or instruction by which to generate the employee and candidate lists. For example, the recruiter may specify that the candidate set is to comprise all connections N degrees from employees in their social network(s).

Scoring

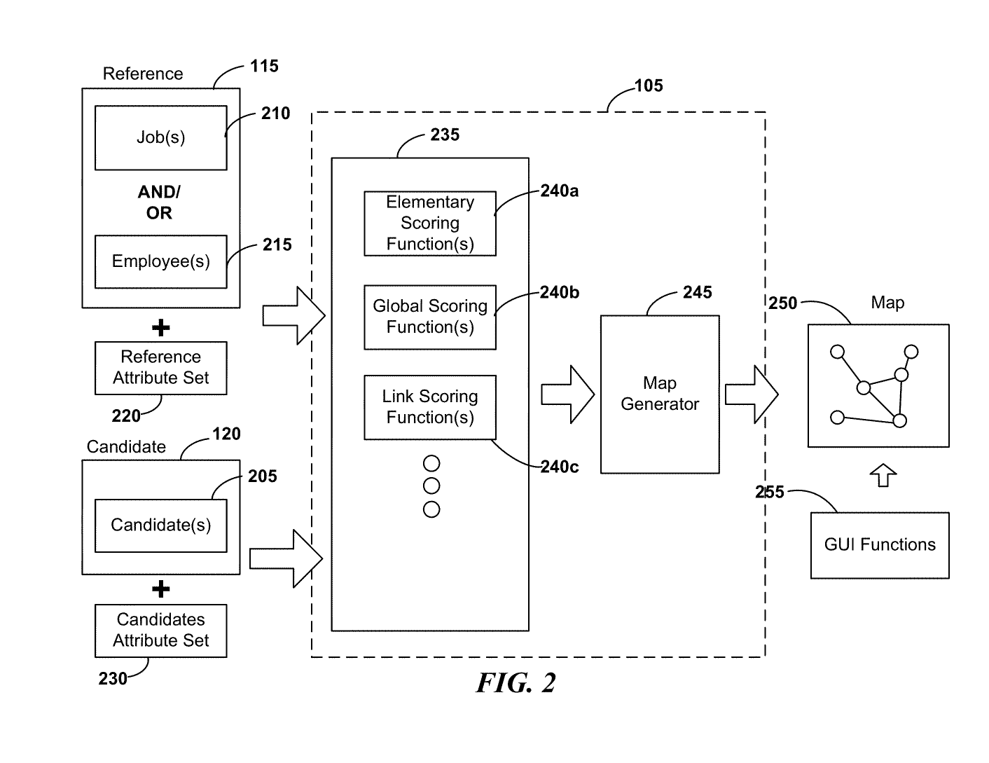

FIG. 2 is a block diagram illustrating components in a scoring portion of a social network visualization system as may be created in some embodiments. The reference set 115 may include both a job listing 210 and an employee listing 215. The candidate set 120 may include a collection of candidates 205 for consideration. Each of the reference set 115 and the candidate set 120 may be accompanied by a corresponding attribute sets 220 and 230 respectively. For example, a job position attribute may indicate that “Experience:Engineering” is a factor, while a candidate profile may specify that the candidate's history includes the attribute “Education:Caltech”. Attributes for employees and/or candidates may be acquired, at least in apart, by scraping the social network 110. The attributes may be correlated to either company values or job skills and knowledge (for instance candidate/job location, schools, school majors, current company, current job title, work history, personal interests, link with others in the set, skills, knowledge, etc.). In some embodiments, the recruiter may specify some attributes manually. In some embodiments, the social network visualization system's scoring system may apply JobDNA and CandidateDNA features disclosed in U.S. Pat. Pub. No. US20130013526. In those embodiments, the visualization system may determine the global score of each of the candidates, employees and jobs in a set, and may determine the detailed score and attributes of each dimensions of the visualization for all candidates, employees and jobs in a set in accordance with the JobDNA and CandidateDNA features.

The visualization system 105 may include a corpus of scoring functions 235. The corpus 235 may include elementary scoring functions 240a, global scoring functions 240b, and linking scoring functions 240c. Additional functions consolidating the results of other functions may also be provided (e.g., business rules, temporal restrictions, processing restrictions, etc.).

Elementary scoring functions 240a may generate metric values between two entities (a job, an employee, or a candidate) using the attributes. For example, each of the attributes “Experience:Engineering” and “Education:Caltech” may be represented as falling in a same class in a elementary scoring function. Consequently, candidate and job entities sharing these attributes may receive a high metric value. An employee attribute “skills:programming” may likewise fall in this set and receive a high metric. In contrast, the candidate attribute “Languages:French” may not result in any substantive metric valuation by this elementary function. Thus, elementary scoring functions 240a may reflect a foundational basis for assessing the relevance of individual attributes between entities.

Global scoring functions 240b may be a weighted combination, or business rule assessment, of elementary scoring function results. The global functions may reflect contextual information particular to the recruiter's search interest. For example, a recruiter may be seeking applicants for a deep-diving welding position. The elementary functions may identify “diving” experience and “welding” experience attributes in various social profiles as being preferred. Accordingly, the elementary functions may ascribe high elementary function values between the job posting and candidates with these two attributes, but lower values for job postings and candidates with only one of each. However, the global function may mitigate false positives by compensating for the elementary metric values if the candidates are not also licensed for welding underwater.

In some embodiments, a default set of elementary scoring functions 240a may be provided to a recruiter and the recruiter may specify or create one or more of the global scoring functions 240b. In some embodiments, the global score value may be computed between each pair of attributes (and the corresponding elementary functions) in each entity.

Link scoring functions 240c may be used to specify how links are to be depicted between entities (e.g., between jobs and employees, between employees and candidates, etc.). A link function may be based upon the result of an elementary scoring function (e.g. a friendship link) or based upon a threshold in a global function. For example, an employee with a long-existing connection to a candidate may have a stronger link value than an employee with only a recent connection to the same candidate. In some embodiments, links between entities are determined based on elementary or global scoring functions. In these instances, the link scoring function may inform the character of the link (e.g., coloring, transparency, thickness, etc.).

A map generator 245 may then generate a map 250 using the scoring functions 240. GUI functions 255 (e.g., dragging operations) may be influenced by parameters of the map 250 set based upon the functions 240 (e.g., the results of a link function may determine an elasticity between nodes in a physics model).

Process Flow

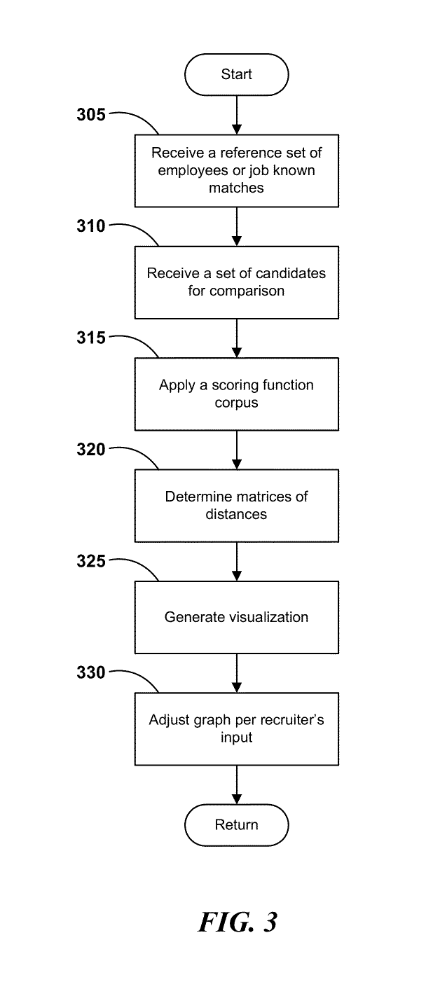

FIG. 3 is a flow diagram illustrating a process for generating a network visualization as may be applied in some embodiments. At block 305, the visualization system may receive a reference set of employees and known job matches (e.g. a reference set). At block 310, the visualization system may receive a candidate set. At block 315, the visualization system may apply one or more functions in a corpus of scoring functions to determine relations between each of the entities. The recruiter may specify the parameters for some of the functions manually (e.g., the recruiter may create global functions and define relevant linking functions). At block 320, the visualization system may determine a multi-dimensional matrix of distances between each of the entities based upon the scoring results. For example, a matrix reflecting candidates on one axis and employees on another may be used to reflect how related each candidate is to the employee. Candidates with similar attributes to the employee, and/or close relations may receive higher metric values in the matrix than other candidates. Thus, the matrix entries may reflect the values of elementary, global, and linking function values (e.g., a weighted average) as applied between the attributes of two entities.

At block 325, the visualization system may generate a visualization of the determined relations in the matrices. As the recruiter views and manipulates the visualization, at block 330, the system may modify the generated image. Though depicted herein as an edge-node relation in two dimensions, the outputted visualization may be other forms, e.g., in three dimensions, in some embodiments and may be based on the projection of multiple dimensions into a visualization space of two or three dimensions.

Example GUI

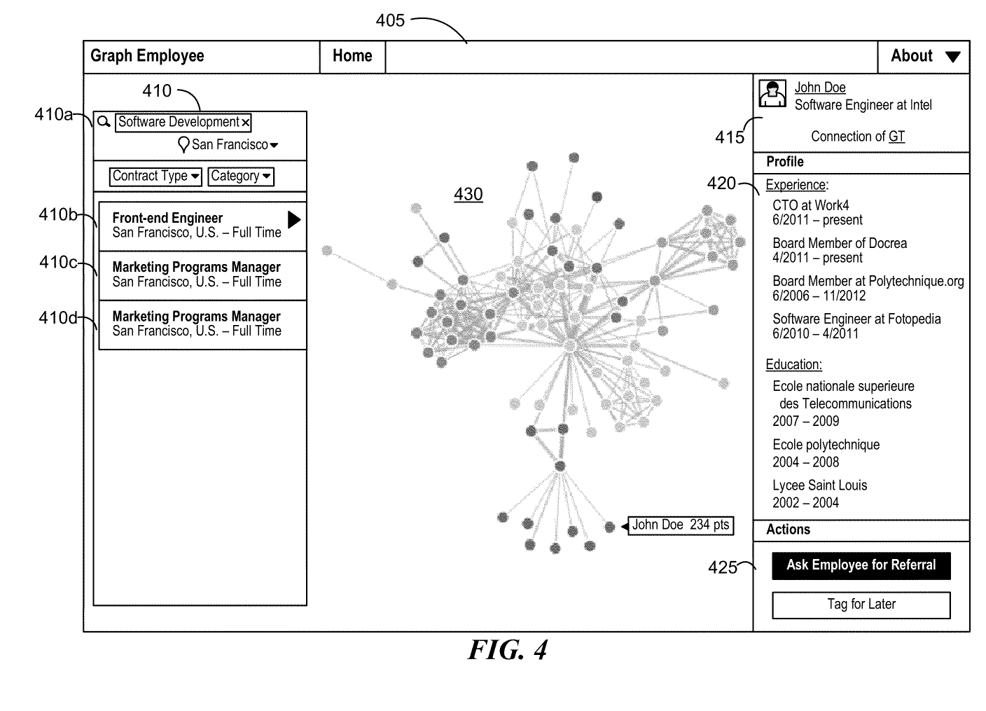

FIG. 4 is an example Graphical User Interface (GUI) 405 presenting a network visualization as may be implemented in some embodiments. Edge-node relations in the region 430 may depict entities as nodes and the existence of relationships between entities by the edges. Where intervening social network users separate an employee and a candidate, these intervening users may or may not be depicted in the visualization, depending upon the embodiment, so as to avoid clutter. Closely related entities may be reflected by shorter edge distances or differently colored edges. For example, the nodes may be color coded to reflect whether they correspond to a job, an employee, a candidate etc.

Hovering a cursor over a node may present information regarding that node (e.g. the employee's name). Selecting an employee node (or other entity) may present the detailed regions 415, 420, and 425 with further information regarding the employee (e.g. employee attributes consolidated from the initial inputs, an organization database, and a social network). The region 420 may specify particular characteristics of the employee, such as work history and acquired skills. A similar presentation may be provided for candidates based upon social network data. An actions region 425 may allow the recruiter to take an action based upon the selected node. For example, the employee may be asked to make a referral to an identified candidate closely related to the employee.

An overlay 410 may present rows 410b, 410c, and 410d of job posting information based upon filtering criteria specified in row 410a. The corresponding nodes in the visualization 430 may be highlighted, or otherwise identified, so that the recruiter may readily identify the most closely related employees and/or candidates. In some embodiments, nodes may be colored (e.g., within a spectrum or by transparency) based upon how they match one or more selected job positions. A similar overlay may be provided for candidates and/or employees in some embodiments.

In some embodiments, the visualization 430 may present the edge-node network in conjunction with a physics model. The physics model may allow the nodes to be moved and dynamically adjusted, while abiding by physical constraints (e.g., Hooke's law). Thus, the edges may be associated with a spring constant. In some embodiments, more similar entities (e.g., as determined by a link metric) may receive higher spring constant values at their corresponding edge.

In some embodiments, the results of the global scoring function(s) can be mapped to other graph dimensions, e.g., the distance between nodes, the size of the nodes, and/or the color/transparency of nodes, etc. In this manner, the recruiter can readily assess the results of metrics they specified within the network. The GUI may allow the recruiter to dynamically modify the weight of each factor of the global function and to update the visualization accordingly. This may allow the recruiter to modify their preferences for the more significant social attributes, and to explore the similar connections in the network.

Example Application #1

Consider a situation where a human resources recruiter wishes to filter out the bad candidates for a Python developer job among 100 candidates. In this example, a good candidates must “fit” the company values and must have a set of predefined skills. Also in this example, location is not a factor (e.g., work from home allowed).

Here the recruiter may specify a set of candidates and the set of the company employees in the technical department. The system may apply scoring functions based upon a combination of job attributes and candidate attributes: (same salary, job category, etc.). Skills, interests and work history may be set to high weights, school and friends to medium, location to low. The link function applied may be based upon a threshold of the previous scoring function, e.g., the global scoring function assessing correspondences in skills, interests, work history, etc.

Following processing, the system may present a map of the candidates relative to the current employees. The candidates outside of the cloud of current employees (e.g. exceeding a threshold similarity) may be construed as failing to meet the desired criteria while candidates sufficiently similar to the employees may be construed as meeting the desired criteria. The recruiter may then interview the fitting candidates.

Example Application #2

As another example, consider a human resources recruiter wishing to explore the social network of company employees in order to encourage referrals from some of those employees. Again, good candidates must “fit” the job and so the recruiter would like for the visualization to reflect candidate correspondences to the employee's skills.

The recruiter may prepare a reference set including a job to fill and the list of employees. The candidate set may include all the friends of employees as derived, for example, from a social network. The link function applied may determine if a “friendship” link exists between employees and candidates. If so, an edge may be placed between the corresponding nodes in the visualization. The recruiter may direct the system to apply scoring functions based upon a combination of job attributes and candidate attributes: (same location, job category, etc.).

The human resource recruiter may the visualize the best matches among the connections of the employees. In this manner, the recruiter may identify “ambassadors” (employees with strong networks) and request that they provide referrals. The visualization summarizes this information in a single view, despite working with a potentially large set of data. This improves the recruiter's efficiency and effectiveness.

Additional Domains

While the above embodiments have been described in relation to pairings for job postings, various of the disclosed approaches may be applied to pairings in other domains, e.g., pairing candidates (candidates) with personal ads (job descriptions) in an online dating context based upon past relationships (employees), classified listings, etc.

Computer System

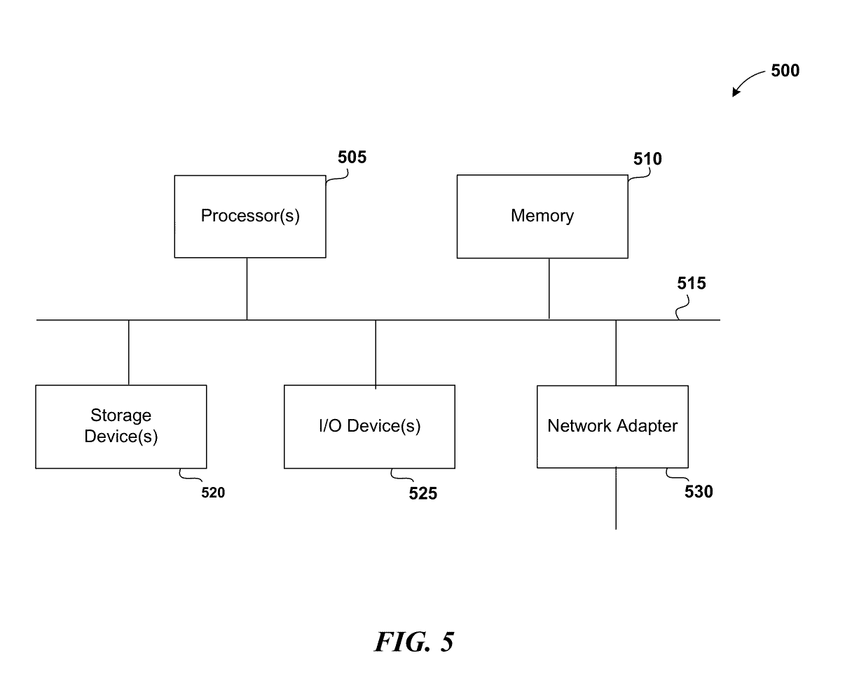

FIG. 5 is a block diagram of a computer system as may be used to implement features of some of the embodiments. The computing system 500 may include one or more central processing units (“processors”) 505, memory 510, input/output devices 525 (e.g., keyboard and pointing devices, display devices), storage devices 520 (e.g., disk drives), and network adapters 530 (e.g., network interfaces) that are connected to an interconnect 515. The interconnect 515 is illustrated as an abstraction that represents any one or more separate physical buses, point to point connections, or both connected by appropriate bridges, adapters, or controllers. The interconnect 515, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 510 and storage devices 520 are computer-readable storage media that may store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media (e.g., “non transitory” media) and computer-readable transmission media.

The instructions stored in memory 510 can be implemented as software and/or firmware to program the processor(s) 505 to carry out actions described above. In some embodiments, such software or firmware may be initially provided to the processing system 500 by downloading it from a remote system through the computing system 500 (e.g., via network adapter 530).

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

We claim:

1. A computer-implemented method for presenting a visualization of candidate and employee relations, comprising:
receiving a first dataset indicating a plurality of candidates;
determining a plurality of candidate attributes for the plurality of candidates based upon a social network;
receiving a second dataset indicating a plurality of job positions associated with an organization;
receiving a third dataset indicating a plurality of employees associated with the organization;
applying a plurality of elementary functions to the plurality of candidate attributes and a plurality of employee attributes to generate a plurality of elementary function values;
applying a global function based upon at least two of the plurality of elementary function values to generate a global function value;
applying a linking function between a candidate from the plurality of candidates and an employee from the plurality of employees to generate a linking function value; and
generating an edge-node visualization based upon the global function value and the linking function value, wherein each of the plurality of candidates, plurality of jobs, and plurality of employees are depicted as nodes in the edge-node visualization.

2. The computer-implemented method of claim 1, wherein the length of the edge is determined based upon the link function.

3. The computer-implemented method of claim 1, further comprising determining a plurality of employee attributes for the plurality of employees based upon data from a social network.

4. The computer-implemented method of claim 1, wherein receiving a first dataset indicating a plurality of candidates comprises retrieving social connections associated with the plurality of employees from the social network.

5. The computer-implemented method of claim 1, wherein a spring constant associated with an edge in the edge-node visualization is determined based upon the linking function.

6. The computer-implemented method of claim 1, wherein a size of a node in the edge-node visualization corresponds to the global function value.

7. A non-transitory computer readable medium comprising instructions configured to case a computer system to perform a method comprising:
receiving a first dataset indicating a plurality of candidates;
determining a plurality of candidate attributes for the plurality of candidates based upon a social network;
receiving a second dataset indicating a plurality of job positions associated with an organization;
receiving a third dataset indicating a plurality of employees associated with the organization;
applying a plurality of elementary functions to the plurality of candidate attributes and a plurality of employee attributes to generate a plurality of elementary function values;
applying a global function based upon at least two of the plurality of elementary function values to generate a global function value;
applying a linking function between a candidate from the plurality of candidates and an employee from the plurality of employees to generate a linking function value; and
generating an edge-node visualization based upon the global function value and the linking function value, wherein each of the plurality of candidates, plurality of jobs, and plurality of employees are depicted as nodes in the edge-node visualization.

8. The non-transitory computer readable medium of claim 7, wherein the length of the edge is determined based upon the link function.

9. The non-transitory computer readable medium of claim 7, further comprising determining a plurality of employee attributes for the plurality of employees based upon data from a social network.

10. The non-transitory computer readable medium of claim 7, wherein receiving a first dataset indicating a plurality of candidates comprises retrieving social connections associated with the plurality of employees from the social network.

11. The non-transitory computer readable medium of claim 7, wherein a spring constant associated with an edge in the edge-node visualization is determined based upon the linking function.

12. The non-transitory computer readable medium of claim 7, wherein a size of a node in the edge-node visualization corresponds to the global function value.

13. A computer system comprising:
at least one processor;
at least one memory comprising instructions configured to cause the at least one processor to perform a method comprising:
receiving a first dataset indicating a plurality of candidates;
determining a plurality of candidate attributes for the plurality of candidates based upon a social network;
receiving a second dataset indicating a plurality of job positions associated with an organization;
receiving a third dataset indicating a plurality of employees associated with the organization;
applying a plurality of elementary functions to the plurality of candidate attributes and a plurality of employee attributes to generate a plurality of elementary function values;
applying a global function based upon at least two of the plurality of elementary function values to generate a global function value;
applying a linking function between a candidate from the plurality of candidates and an employee from the plurality of employees to generate a linking function value; and
generating an edge-node visualization based upon the global function value and the linking function value, wherein each of the plurality of candidates, plurality of jobs, and plurality of employees are depicted as nodes in the edge-node visualization.

14. The computer system of claim 13, wherein the length of the edge is determined based upon the link function.

15. The computer system of claim 13, further comprising determining a plurality of employee attributes for the plurality of employees based upon data from a social network.

16. The computer system of claim 13, wherein receiving a first dataset indicating a plurality of candidates comprises retrieving social connections associated with the plurality of employees from the social network.

17. The computer system of claim 13, wherein a spring constant associated with an edge in the edge-node visualization is determined based upon the linking function.

18. The computer system of claim 13, wherein a size of a node in the edge-node visualization corresponds to the global function value.
